(19) United States
(12) Patent Application Publication
(10) Pub. No.: US 2019/0079790 A1
(43) Pub. Date: Mar. 14, 2019

(54) INFORMATION PROCESSING APPARATUS AND INFORMATION PROCESSING SYSTEM

(71) Applicant: FUJITSU LIMITED, Kawasaki-shi (JP)

(72) Inventor: Kenji Tagashira, Kawasaki (JP)

(73) Assignee: FUJITSU LIMITED, Kawasaki-shi (JP)

(21) Appl. No.: 16/118,540

(22) Filed: Aug. 31, 2018

(30) Foreign Application Priority Data
Sep. 8, 2017 (JP) 2017-173181

(51) Int. Cl. G06F 9/455

(52) U.S. Cl. CPC G06F 9/45558; G06F 2009/4557; G06F 2009/45583; G06F 2009/45575; G06F 2009/45595

(57) ABSTRACT

An information processing apparatus includes a processor that transmits data stored in a first memory of a migration source virtual machine operating on the information processing apparatus to a second memory of a migration destination virtual machine on a migration destination apparatus. The processor suspends the migration source virtual machine after the transmission. The processor re-transmits re-written data stored in the first memory to the second memory. The re-written data is data re-written during the transmission. The processor notifies the migration destination apparatus of first time information related to a suspension time to cause the migration destination apparatus to adjust second time information by adding the suspension time. The second time information is related to an internal clock of the migration source virtual machine and stored in the second memory. The processor causes, after the re-transmission, the migration destination apparatus to resume the migration destination virtual machine.

### CROSS-REFERENCE TO RELATED APPLICATION

This application is based upon and claims the benefit of priority of the prior Japanese Patent Application No. 2017-173181, filed on Sep. 8, 2017, the entire contents of which are incorporated herein by reference.

### FIELD

The embodiments discussed herein are related to an information processing apparatus, an information processing system, and a control method of the information processing system.

### BACKGROUND

In a cloud computing (hereinafter, also simply referred to as a cloud), virtualization software operating on a physical machine (hereinafter, referred to as a hypervisor) virtualizes a hardware group such as a plurality of physical machines within a server center, based on a virtual machine configuration definition within a configuration file of a virtual machine.

Live migration is a technique of migrating a virtual machine generated in a physical machine as a migration source to a physical machine as a migration destination without substantially stopping the operation of the virtual machine. The live migration is a technique required for maintenance of hardware under a cloud environment.

In the live migration, all the data within a main memory (hereinafter, simply referred to as a memory) of the virtual machine of a migration source is transmitted to an area of a memory allocated to the virtual machine of a migration destination, and the virtual machine of the migration source is suspended (temporarily stopped). Then, a dirty page within the memory of the migration source virtual machine, which is re-written during the transmission, is transmitted to the memory of the migration destination virtual machine. Then, after the transmission of the dirty page ends, the migration destination virtual machine resumes. Accordingly, the migration destination virtual machine may resume the operation thereof at a state immediately before the migration source virtual machine is suspended. Then, a virtual machine configuration file of the migration source virtual machine is deleted.

Related techniques are disclosed in, for example, Japanese Laid-Open Patent Publication No. 2014-191752 and International Publication Pamphlet No. WO2014/118961.

### SUMMARY

According to an aspect of the present invention, provide is an information processing apparatus including a primary memory and a processor coupled to the primary memory. The processor is configured to transmit data stored in a first memory of a migration source virtual machine operating on the information processing apparatus to a second memory of a migration destination virtual machine on a migration destination apparatus. The first memory is part of the primary memory. The processor is configured to suspend the migration source virtual machine after the transmission. The processor is configured to re-transmit re-written data stored in the first memory to the second memory. The re-written data is data re-written during the transmission. The processor is configured to notify the migration destination apparatus of first time information related to a suspension time to cause the migration destination apparatus to adjust second time information by adding the suspension time. The suspension time is a time from the suspension of the migration source virtual machine to end of the re-transmission. The second time information is related to an internal clock of the migration source virtual machine and stored in the second memory. The processor is configured to cause, after the re-transmission, the migration destination apparatus to resume the migration destination virtual machine.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration of an information processing system under a cloud computing environment in which live migration is executed;

FIG. 2 is a view illustrating an example of a hardware configuration of a physical machine in FIG. 1;

FIG. 3 is a sequence diagram of a live migration process in the related art;

FIG. 4 is a view illustrating a configuration of an information processing system under a cloud environment in which live migration is executed according to a first embodiment;

FIG. 5 is a view illustrating a live migration control process by a live migration control program and a hypervisor according to the first embodiment;

FIG. 6 is a sequence diagram of a live migration process according to the first embodiment;

FIG. 7 is a sequence diagram of a live migration process according to a second embodiment; and

FIG. 8 is a sequence diagram of the live migration process according to the second embodiment.

### DESCRIPTION OF EMBODIMENTS

In the live migration, the virtual machine is temporarily stopped between a time point at which the migration source virtual machine is suspended and a time point at which the migration destination virtual machine is resumed. Thus, there is a problem in that the time of the virtual machine is delayed by the time between the suspension and resumption. In order to solve the problem, it is desirable to connect the migration destination virtual machine to an external NTP (network time protocol) server after resumption, and to adjust the time. However, the time adjustment by the NTP server is gradually performed over an extended time period, during which the time of the migration destination virtual machine is in a delayed state, and, for example, a log time deviation and a time lag of a transaction occur. Thus, it is difficult to use the live migration in a service system in which a time delay is not allowed.

Therefore, in a service system where a time delay is not allowed, it is desirable to shut down (stop) the service system without using live migration, and start the virtual machine in the migration destination physical machine. In such a case, it is impossible to avoid stopping the operation of the service system. As a result, it is difficult to construct a service system in which the time delay or an operation stop is not allowed, under a cloud environment.

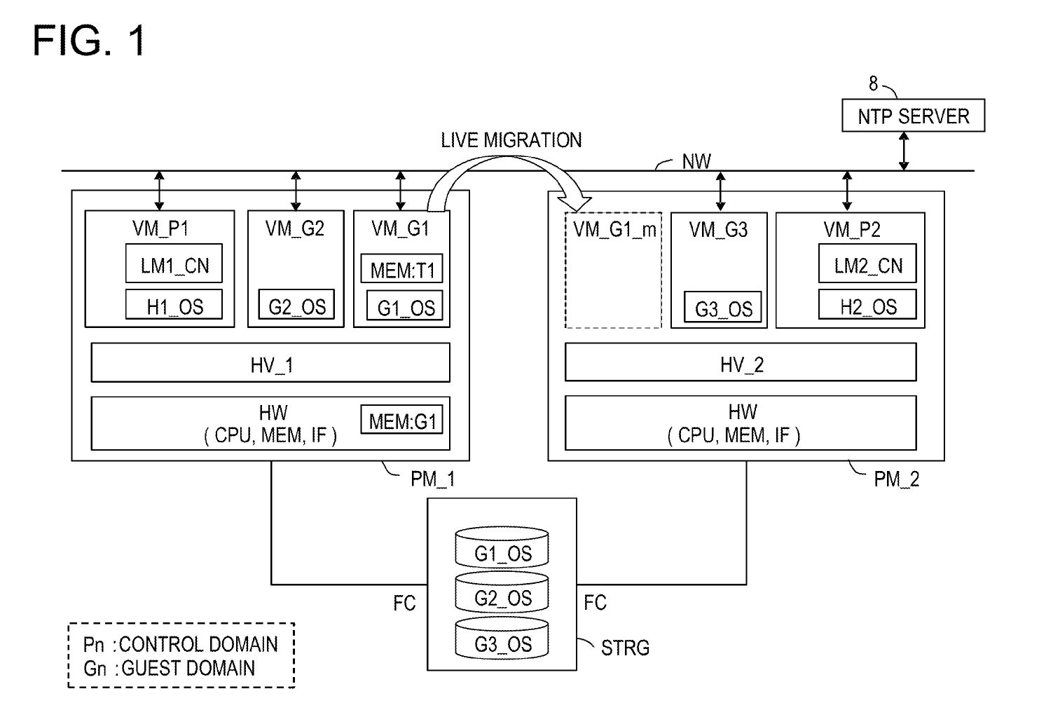

FIG. 1 is a view illustrating a configuration of an information processing system under a cloud-computing environment in which live migration is executed. The information processing system in FIG. 1 includes a plurality of physical machines PM_1 and PM_2, and a storage device STRG as a large capacity memory accessible by such physical machines. Each physical machine is a computer or an information processing apparatus, and has a hardware resource HW. The hardware resource includes, for example, a central processing unit (CPU, a central arithmetic processing unit or a processor), a main memory MEM, and an interface IF with an external network.

The physical machine PM_1 executes a hypervisor HV_1 as virtualization software, and generates a plurality of virtual machines VM_P1, VM_G1, and VM_G2. Similarly, the physical machine PM_2 executes a hypervisor HV_2 to generate a plurality of virtual machines VM_P2 and VM_G3.

Each virtual machine VM has the virtual machine VM_P1 or VM_P2 which executes an OS (H1_OS or H2_OS) for a host, and the virtual machine VM_G1, VM_G2, or VM_G3 which executes an OS (G1_OS, G2_OS, or G3_OS) for a guest. The virtual machines VM_P1 and VM_P2 are virtual machine management servers that execute live migration control programs LM1_CN and LM2_CN, respectively, and execute a live migration process of any one of virtual machines. The virtual machines VM_G1, VM_G2, and VM_G3 execute application programs (not illustrated), respectively, and provide services corresponding to the application programs.

The physical machines PM_1 and PM_2 and the respective virtual machines VM are accessible to each other via a network NW. A network time protocol server (NTP server) is disposed on the network NW. The NTP server is accessed by an NTP client from each virtual machine VM and adjusts an internal clock of each virtual machine VM to a correct current time.

Here, the internal clock of each virtual machine is kept as indicated by, for example, the virtual machine VM_G1 in the drawing, while time information T1 is stored in a storage area within the main memory MEM allocated to the virtual machine VM_G1, and the time information T1 within the main memory MEM is updated by a count value counted in synchronization with a clock of the CPU. The keeping of the internal clock is executed by, for example, the OS (a host OS or a guest OS) of the virtual machine.

The storage device STRG stores each guest OS (G1_OS, G2_OS, and G3_OS), an application program executed by each virtual machine (not illustrated), etc. Then, the storage device STRG is connected to the physical machine by a fiber channel FCFB, and is accessible from both physical machines.

In the present embodiment, for example, the migration source virtual machine VM_G1 operating on the physical machine PM_1 in FIG. 1 is migrated to the physical machine PM_2 as a migration destination, and the migration destination virtual machine VM_G1_m continues to perform the operation. In this migration processing, live migration is executed by controlling the time during which operation of the virtual machine VM_G1 is stopped to be a relatively short time substantially close to zero.

In FIG. 1, Pn denotes a control domain (a machine domain by the host OS), and Gn denotes a guest domain (a machine domain by the guest OS).

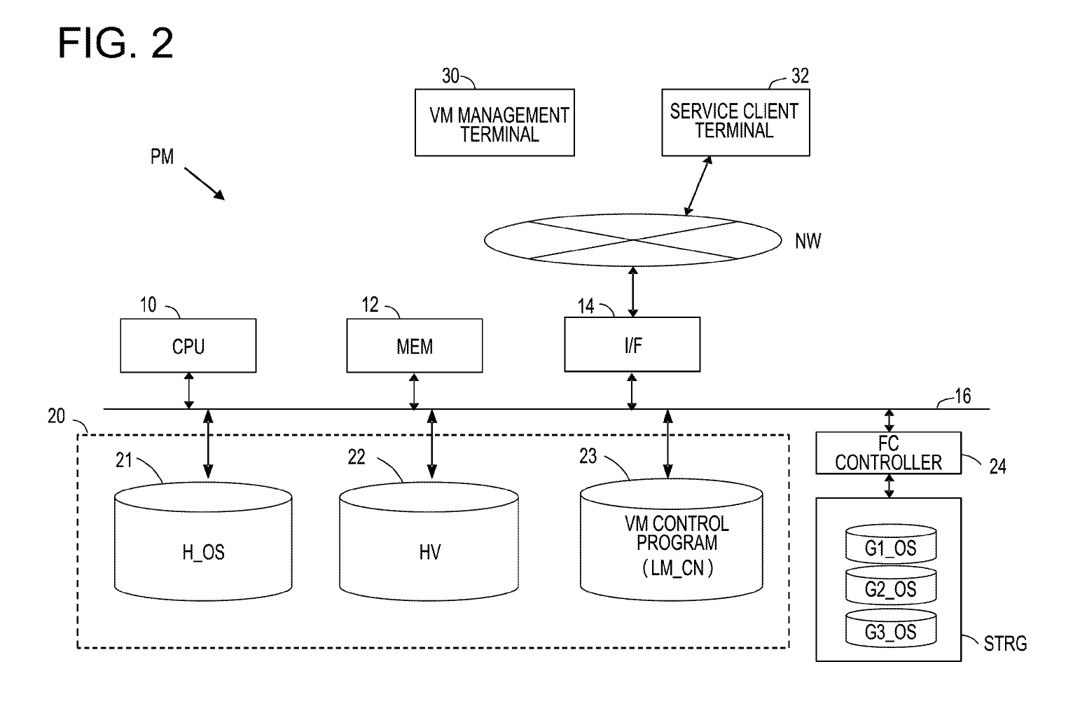

FIG. 2 is a view illustrating an example of a hardware configuration of the physical machine in FIG. 1. The physical machine PM includes a CPU 10, a main memory (MEM) 12, an interface 14 connected to the network NW, and a bus 16 connecting these to each other. The physical machine PM stores a host OS (H_OS) 21, a hypervisor (HV) 22, and a virtual machine (VM) control program 23 within a large-capacity auxiliary storage device 20. The OS, the HV, and the program are developed in the main memory 12, and executed by the CPU (or the processor). The VM control program 23 includes a live migration control program LM_CN to be described below.

The processor executes the host OS (H_OS) and the VM control program 23, and controls a plurality of virtual machines generated on the physical machine. The control of the virtual machine includes start-up, suspension (temporary stop), resumption (returning from temporary stop), and shutdown of the virtual machine. In addition, the control of the virtual machine includes a control of live migration in which the virtual machine is migrated from a migration source physical machine to a migration destination physical machine while the operation state of the virtual machine is substantially maintained.

The network NW is connected to, for example, a VM management terminal 30 of an operation manager who performs an operation management of a server center under a cloud environment, or a service client terminal 32 that uses a service system constituted by the respective virtual machines VM_G1, VM_G2, and VM_G3, besides the NTP server illustrated in FIG. 1. Then, the VM management terminal 30 accesses VM control servers VM_P1 and VM_P2 that manage and control the virtual machines, and performs, for example, a control of the virtual machines or an instruction of live migration.

The physical machine PM is connected to the storage device STRG in an accessible manner via a fiber channel (FC) controller 24. The storage device STRG, as described above, stores each guest OS of the virtual machine VM_G started by the guest OS. When the live migration is executed, for example, instead of a migration source physical machine, which starts the migration source virtual machine VM_G1 as a live migration target, a migration destination physical machine, which resumes the migration destination virtual machine VM_G1_m, accesses to and resumes the guest OS of the migration target virtual machine.

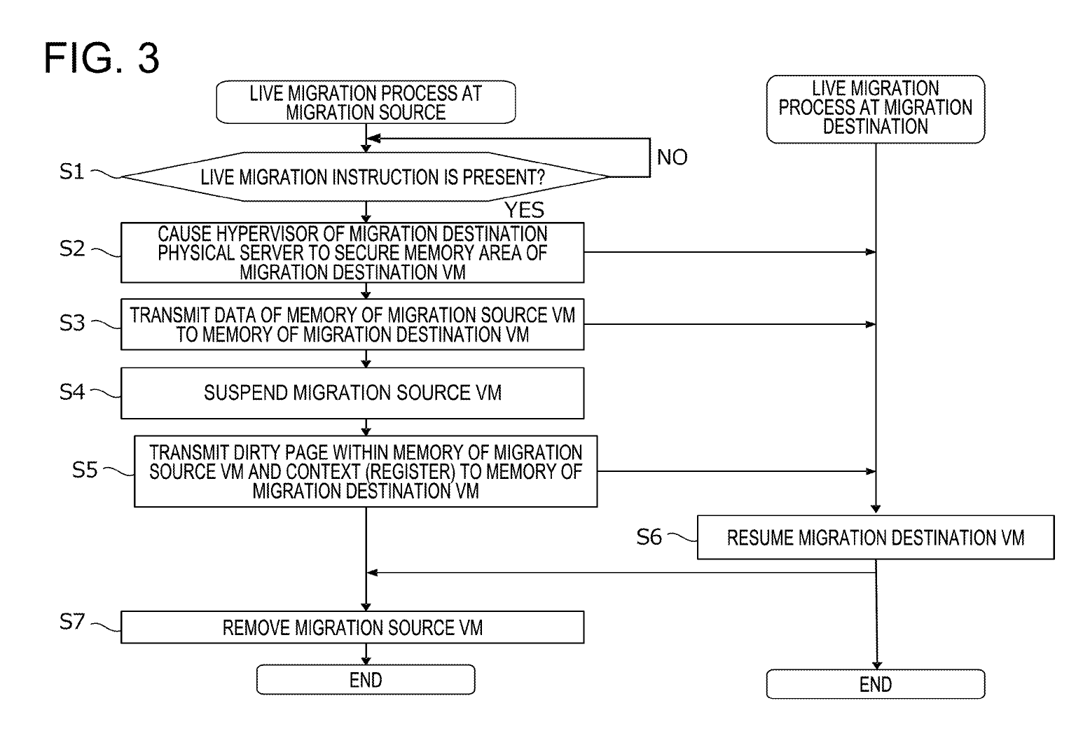

FIG. 3 is a sequence diagram of a live migration process in the related art. The progress of the live migration is performed by a processing in a migration source physical machine (left in FIG. 3), and a processing in a migration destination physical machine (right in FIG. 3). Each process is executed by a live migration control program LM_CN of each of virtual machines VM_P1 and VM_P2 as VM control servers and a hypervisor HV.

First, when an instruction of live migration is given (“YES” in S1), the live migration control program LM1_CN of a migration source physical server PM_1 is executed, and a hypervisor HV_2 of a migration destination physical server PM_2 is caused to secure a memory area of a migration destination virtual machine within the main memory MEM (S2). Then, a hypervisor HV_1 of the migration source physical server transmits data of a memory of a migration source virtual machine VM_G1 to a memory of a migration destination virtual machine VM_G1_m (S3). The memory data transmission is performed a plurality of times, including re-transmission of a dirty page of data re-written during the data transmission.

When the memory data transmission is completed, the hypervisor HV_1 of the migration source physical machine suspends the migration source virtual machine, and stops the operation (S4). In this suspension, the hypervisor HV_1 stops operation of a guest OS (G1_OS) of the migration source virtual machine, and also stops an application being executed by the migration source virtual machine. However, the data within the memory, data of a register within the CPU (context), etc. is not deleted, but is transmitted to the memory of the migration destination virtual machine. Then, when a guest OS (G1_OS) of the migration destination virtual machine VM_G1_m resumes the operation, the data within the memory, the data of the register within the CPU, etc. of the migrated virtual machine is restored from a state immediately before the suspension. Thus, the operation at the time of suspension may be continued.

Meanwhile, when the virtual machine is shut down, each application performs a normal termination processing, and operation data, etc. within the memory is stored in an auxiliary storage device such as a hard disk as necessary. Then, the data within the memory is deleted. Meanwhile, when the virtual machine is operated, the internal time of the operated virtual machine is set at the internal time of a host OS of the VM control server VM_P that executes a VM control program.

After suspension, the hypervisor of the migration source physical machine transmits a dirty page within the memory of the migration source virtual machine, which is re-written during the processing S3, and the context within the CPU, to the memory of the migration destination virtual machine (S5). When this transmission ends, the hypervisor of the migration destination physical machine resumes the guest OS of the migration destination virtual machine (returns from suspension, or resumes), and resumes the operation at the time of suspension (S6). When the migration destination virtual machine is resumed and normally operates, the hypervisor of the migration source physical machine deletes the migration source virtual machine (S7). Specifically, a configuration file stored in the memory by the VM control server VM_P of the migration source virtual machine is deleted. The memory of the migration source virtual machine is released.

In the above described live migration process, since the data transmission time in the processing S3 may not be made zero, a dirty page within the memory does not disappear. Thus, in order to transmit a dirty page, a time from the suspension of the migration source virtual machine in the processing S4 to the resumption of the migration destination virtual machine in the processing S6 may not be made zero.

As described above, when the virtual machine serving as the migration target is suspended, the guest OS (G1_OS) thereof is stopped, and operation of the internal clock T1 by the guest OS is also stopped. Time data of the internal clock T1 within the memory immediately before suspension of the migration source virtual machine has already been transmitted to the memory of the migration destination virtual machine. As a result, the internal clock T1 of the guest OS when the migration destination virtual machine is resumed and the operation thereof resumes, still keeps the time point prior to the suspension. Thus, there is a problem in that the time point is delayed by a time corresponding to a time during suspension (a suspension time).

In order to suppress the time delay discussed above, the number of times of the processing S3 may be increased so as to reduce a dirty page capacity transmitted during suspension. In addition, a CPU resource of the VM control server VM_P1 that controls a dirty page transmission may be increased so as to minimize the suspension time.

### First Embodiment

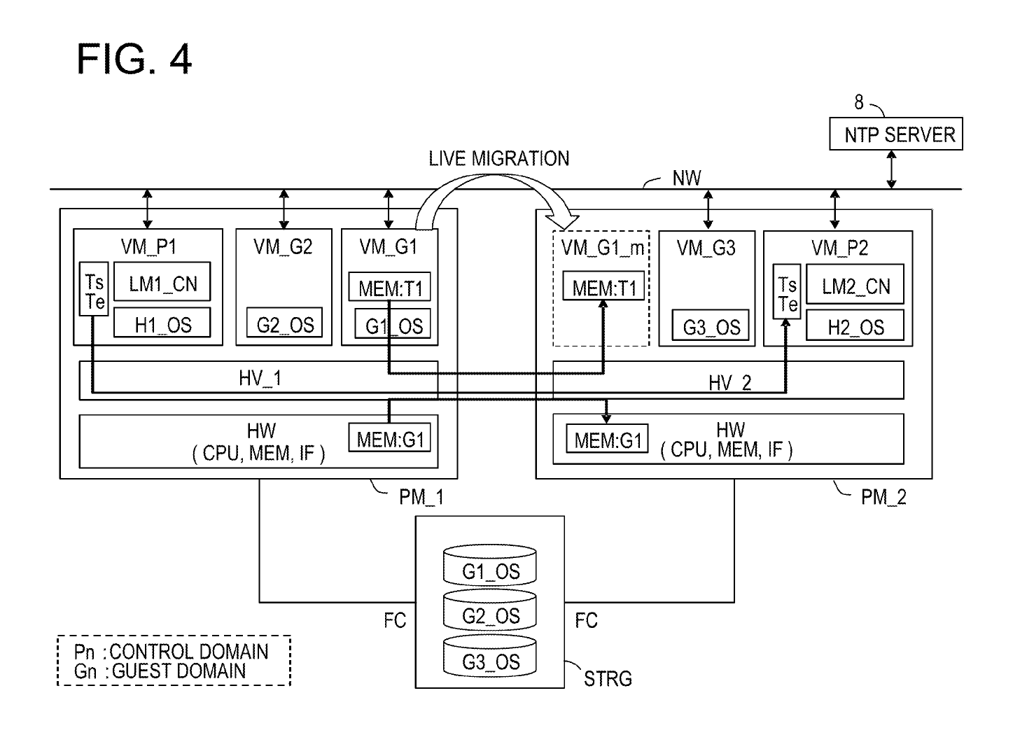

FIG. 4 is a view illustrating a configuration of an information processing system under a cloud environment in which live migration is executed according to the first embodiment. As in FIG. 1, the information processing system in FIG. 4 includes a plurality of physical machines PM_1 and PM_2, and a storage device STRG as a large capacity memory accessible by such physical machines. Also, as in FIG. 1, virtual machines VM_P1, VM_G1, and VM_G2 are generated on the physical machine PM_1, and virtual machines VM_P2 and VM_G3 are generated on the physical machine PM_2.

The configuration of the information processing system in FIG. 4 is different from that in FIG. 1 as follows.

(1) First, the virtual machine VM_P1 as a VM control server of the migration source physical machine PM_1 executes a live migration control program LM1_CN so as to record a point in time Ts at which the migration source virtual machine VM_G1 is suspended or dirty page transmission is started after suspension, and a point in time Te at which dirty page transmission is ended, in a memory. These points in time Ts and Te are points in time by an internal clock kept in the memory by the host OS of the virtual machine VM_P1 as the VM control server.

(2) Second, the VM control server VM_P1 of the migration source physical machine PM_1 transmits the points in time Ts and Te (suspension time-related information) in the memory to the virtual machine VM_P2 of the migration destination physical machine PM_2 via hypervisors HV_1 and HV_2.

(3) Third, the virtual machine VM_P2 of the migration destination physical machine PM_2 executes a live migration control program LM2_CN, so that a suspension time Te-Ts obtained from the suspension time-related information Ts and Te is added to an internal time T1 within the memory MEM of the migration destination virtual machine VM_G1_m to adjust the internal time T1 to T1+(Te-Ts). Accordingly, the time delay of the internal time T1 is suppressed or unlimitedly minimized.

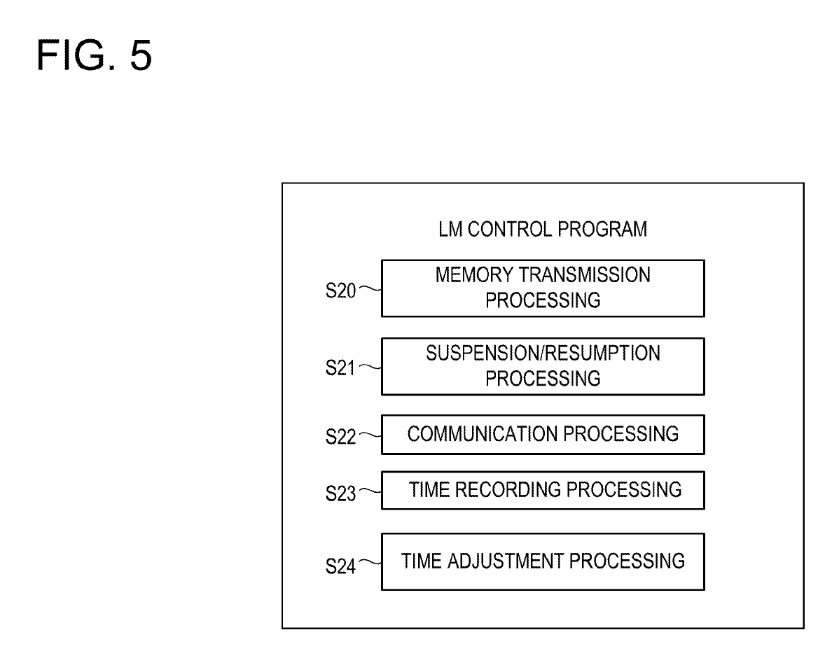

FIG. 5 is a view illustrating a live migration control process by a live migration control program and a hypervisor according to the present embodiment. The live migration control process includes: a memory transmission processing S20 of transmitting data of the memory of the migration source virtual machine to the memory of the migration destination virtual machine; a suspension/resumption processing S21 of suspending the migration source virtual machine and resuming the migration destination virtual machine; and a communication processing S22 between the virtual machine VM_P1 and the hypervisor HV_1 of the migration source physical machine and the virtual machine VM_P2 and the hypervisor HV_2 of the migration destination physical machine. Further, the live migration control process includes: a time recording processing S23 of recording a suspension start time or a dirty page transmission start time Ts, a dirty page transmission end time Te, etc. by the VM control server VM_P1 of the migration source physical machine; and a time adjustment processing S24 of adjusting the memory internal time T1 of the migration destination virtual machine by adding the suspension time based on the points in time Ts and Te, by the VM control server VM_P2 of the migration destination physical machine. The time recording processing S23 and the time adjustment processing S24 are added in the present embodiment.

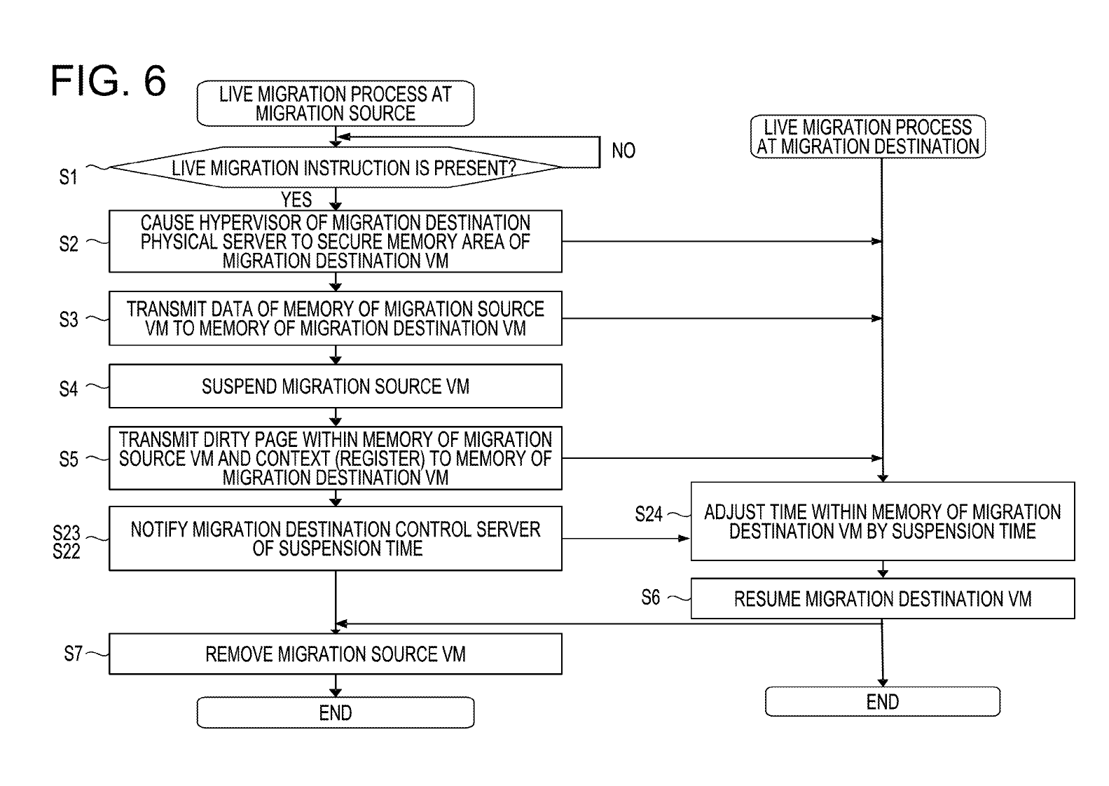

FIG. 6 is a sequence diagram of a live migration control process in the present embodiment. The processings S23 and S22 in the migration source and the processing S24 in the migration destination are added to the sequence diagram illustrated in FIG. 3. Other processings are the same as those described in FIG. 3.

That is, in the live migration process at the migration source (left in FIG. 6), the migration source virtual machine VM_G1 is suspended by the live migration control program LM1_CN of the VM control server VM_P1 and the hypervisor HV_1 in the migration source physical machine (S4), and a dirty page within the memory of the migration source virtual machine and a context within the register of the CPU are transmitted to the memory of the migration destination virtual machine VM_G1_m (S5). Then, the VM control server VM_P1 of the migration source physical machine records a start time Ts and an end time Te of a transmission processing of a dirty page, within the memory based on the internal clock within the memory of the host OS (H1_OS) of the VM control server VM_P1 (S22). Instead of the start time Ts in the transmission processing of the dirty page, a point in time at which the migration source virtual machine is suspended may be recorded as Ts.

Then, the VM control server VM_P1 notifies the migration destination control server VMP2 of the time information Ts and Te related to the suspension time. This notification is performed through the hypervisor HV_1 at the migration source and the hypervisor HV_2 at the migration destination.

Next, in the live migration process at the migration destination (right in FIG. 6), the VM control server VM_P2 at the migration destination performs adjustment by adding the suspension time Te-Ts (specifically, a time required for a dirty page transmission or a time from a point in time of suspension to a point in time at which the dirty page transmission ends) to a point in time T1 within the memory of the guest OS of the migration destination virtual machine VM_G1_m (S24). Since the time Te-Ts corresponding to the suspension time of the migration source virtual machine is added to the internal time T1 within the memory of the migration destination virtual machine, thereafter, when the migration destination virtual machine is resumed by the live migration control program LM2_CN of the VM control server VM_P2 and the hypervisor HV_2 at the migration destination, the operation resumes at the adjusted internal time T1. Accordingly, after the resumption, a time delay is suppressed or unlimitedly minimized in the virtual machine.

### Second Embodiment

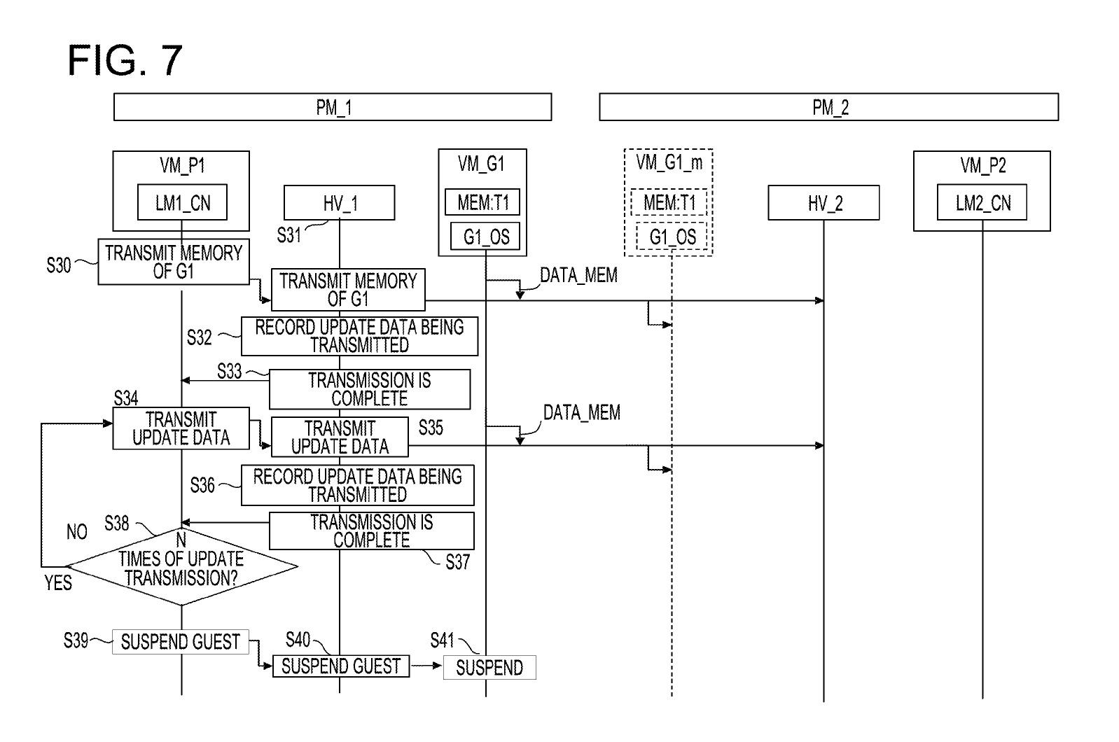

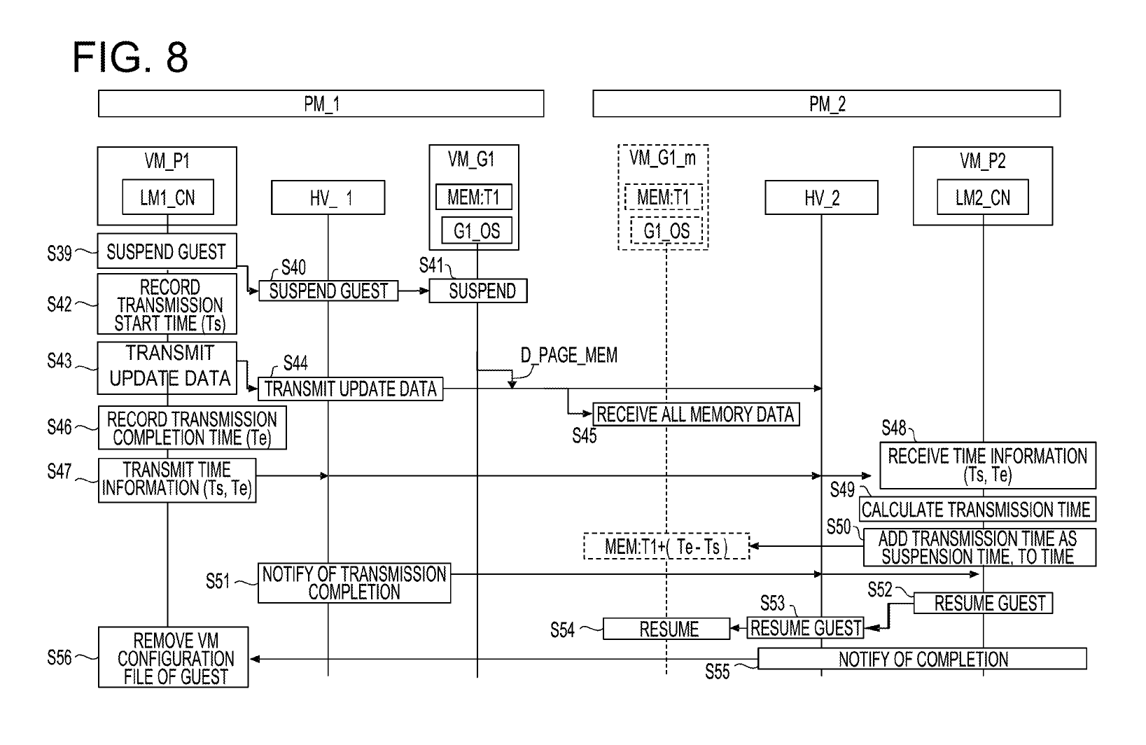

FIGS. 7 and 8 are sequence diagrams of a live migration process according to the second embodiment. Hereinafter, details of the live migration process in the present embodiment will be described with reference to FIGS. 7 and 8.

In FIGS. 7 and 8, the processings by the live migration control program LM1_CN of the migration source control server VM_P1 and the hypervisor HV_1 in the migration source physical server PM_1, and the processings by the live migration control program LM2_CN of the migration destination control server VM_P2 and the hypervisor HV_2 are distinguished from each other in the description. However, the sharing of the processings illustrated in the drawing is exemplary only, but the sharing of the processings by the live migration control program and the hypervisor is not limited to this example. Hereinafter, the live migration will be written as abbreviation, LM (live migration).

First, as illustrated in FIG. 7, when a live migration instruction is received from the VM management terminal 30 (FIG. 2), a processor of the VM control server VM_P1 at the migration source executes the LM control program LM1_CN to issue an instruction to transmit data in the memory of the migration source virtual machine VM_G1 (S30). Then, the hypervisor HV_1 executes a transmission of the data of the memory (S31). Accordingly, data DATA_MEM within the main memory MEM of the migration source virtual machine VM_G1 is transmitted into the main memory allocated to the migration destination virtual machine VM_G1_m of the migration destination physical machine.

During the above transmission of the data of the memory, the hypervisor HV_1 at the migration source records update data (a dirty page) in the memory that is re-written by the migration source virtual machine (S32). Then, when the transmission of the data of the memory is completed, the hypervisor HV_1 notifies the migration source control server VM_P1 (S33).

Accordingly, the migration source control server VM_P1 executes the LM control program LM1_CN to issue an instruction to transmit the update data (S34). Then, the hypervisor HV_1 executes a transmission of the data of the memory (S35), and records the update data (the dirty page) being transmitted (S36). Then, when the transmission of the dirty page of the memory is completed, the hypervisor HV_1 notifies the migration source control server VM_P1 (S37).

The above processings S34 to S37 are repeated N times (S38). As for the N times, an optimum number of times is selected such that a suspension time of the migration source virtual machine may be shortened as much as possible, and a time required when the dirty page is transmitted N times is not long.

When the dirty page is transmitted N times (“YES” in S38), the VM control server VM_P1 at the migration source issues an instruction to suspend the guest OS (G1_OS) of the migration source virtual machine VM_G1, and the hypervisor HV_1 suspends the guest OS (S40). As a result, the operation of the migration source virtual machine VM_G1 is suspended (S41). Due to this suspension, a context such as a register value within the CPU of the migration source virtual machine is stored in the memory of the migration source virtual machine.

Referring to FIG. 8, the VM control server VM_P1 at the migration source executes the LM control program LM1_CN to record a point in time immediately after the migration source virtual server VM_G1 is suspended, that is, a transmission start time Ts of a dirty page after suspension, to the memory MEM, etc. (S42). The processing of recording the transmission start time Ts is performed by the time recording processing S23 in FIG. 5. The time Ts is a time based on the internal clock managed within the memory by the host OS of the VM control server VM_P1.

Then, the migration source control server VM_P1 executes the LM control program LM1_CN to issue an instruction to transmit update data within the memory of the migration source virtual machine VM_G1 (S43), and the hypervisor HV_1 executes transmission of the update data (S44). Accordingly, D_PAGE_MEM such as the update data within the memory of the migration source virtual machine VM_G1 and the context of the register within the CPU is transmitted to the memory allocated to the migration destination virtual machine. As a result, the memory of the migration destination virtual machine VM_G1 of the migration destination physical machine receives and stores all the latest data within the memory of the migration source virtual machine (S45). The above update data within the memory of the migration source virtual machine also includes time data of the internal clock managed within the memory by the guest OS (G1_OS). In the transmission processing of the update data, the hypervisor HV_1 at the migration source may transmit configuration data of the suspended migration source virtual machine, to the hypervisor HV_2 at the migration destination.

When all the latest data within the memory at the migration source is stored in the memory at the migration destination, the migration source control server VM_P1 executes the LM control program LM1_CN to record a transmission completion time Te (S46). Then, the migration source control server VM_P1 executes the LM control program LM1_CN so as to set information on two points in time Ts and Te as suspension time-related information, and to transmit the information to the migration destination control server VM_P2 (S47, S48). Otherwise, a time Te-Ts between two points in time may be transmitted as the suspension time-related information. Then, as described above, this transmission of the time information is performed through the hypervisor HV_1 at the migration source and the hypervisor HV_2 at the migration destination.

In response to reception of the suspension time-related information Ts and Te, the VM control server VM_P2 at the migration destination executes the LM control program LM2_CN to calculate a suspension time or a transmission time Te-Ts (S49), and to add the suspension time or the transmission time Te-Ts to the internal time T1 within the memory of the migration destination virtual machine VM_G1_m (S50).

The hypervisor HV_1 at the migration source notifies the migration destination control server VM_P2 of the completion of the transmission processing of the update data during suspension, through the hypervisor HV_2 at the migration destination (S51). In response to this notification, the VM control server VM_P2 at the migration destination executes the LM control program LM2_CN to issue an instruction to resume the guest OS of the migration destination virtual machine (S52). In response to this, the hypervisor HV_2 at the migration destination resumes the migration destination virtual machine VM_G1_m (S53, S54). In this resumption processing, the hypervisor at the migration destination resumes the migration destination virtual machine based on the configuration data transmitted from the hypervisor at the migration source.

Finally, the VM control server VM_P2 and the hypervisor HV_2 at the migration destination notify the VM control server VM_P1 at the migration source of the LM completion (S55), and then the VM control server at the migration source deletes a configuration file of the migration source virtual machine, which has been stored within the memory thereof (S56). In this manner, the live migration process is completed.

When the above hypervisor HV_2 at the migration destination resumes the migration destination virtual machine (S53, S54), the guest OS (G1_OS) of the migration destination virtual machine VM_G1_m resumes the operation. At the time of the resumption, the internal time managed by the guest OS have elapsed by the suspension time or the transmission time Te-Ts. As a result, a time delay in the internal time of the guest OS in the migration destination virtual machine that has resumed the operation is substantially eliminated or suppressed.

Strictly speaking, the above suspension time or transmission time Te-Ts is not coincident with a time from suspension of the migration source virtual machine to resumption of the migration destination virtual machine. This is because, for example, it is difficult for the VM control server at the migration source to grasp the point in time at which the migration destination virtual machine is resumed, before the resumption processing S54.

Accordingly, in a modification of the first or second embodiment, the internal time T of the migration destination virtual machine may be adjusted by adding an adjustment time (Te-Ts)×a or (Te-Ts)+ΔT, which is obtained through adjustment in which the above suspension time or transmission time Te-Ts is lengthened by a predetermined ratio a or a predetermined time period ΔT. Δs for the predetermined ratio a or the predetermined time period ΔT, a ratio a or a time ΔT by which a delay time in the virtual machine after the resumption approaches zero may be detected through an experiment, etc.

As described above, according to the present embodiment, the time delay of virtual machine of the migration destination after the live migration may be suppressed or caused to approach zero. As a result, it is possible to configure a service system in which a time delay is not allowed by a cloud computing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a primary memory; and
a processor coupled to the primary memory and the processor configured to:
transmit data stored in a first memory of a migration source virtual machine operating on the information processing apparatus to a second memory of a migration destination virtual machine on a migration destination apparatus, the first memory being part of the primary memory;
suspend the migration source virtual machine after the transmission;
re-transmit re-written data stored in the first memory to the second memory, the re-written data being data re-written during the transmission;
notify the migration destination apparatus of first time information related to a suspension time to cause the migration destination apparatus to adjust second time information by adding the suspension time, the suspension time being a time from the suspension of the migration source virtual machine to end of the re-transmission, the second time information being related to an internal clock of the migration source virtual machine and stored in the second memory; and
cause, after the re-transmission, the migration destination apparatus to resume the migration destination virtual machine.

2. The information processing apparatus according to claim 1, wherein
the processor is further configured to:
record a re-transmission start time at which the re-transmission is started and a re-transmission end time at which the re-transmission is ended; and
notify the migration destination apparatus of, as the first time information, the re-transmission start time and the re-transmission end time, or a time between the re-transmission start time and the re-transmission end time.

3. The information processing apparatus according to claim 1, wherein
the processor is further configured to adjust the second time information by adding an augmented suspension time that is obtained by augmenting the suspension time in a predetermined manner.

4. An information processing system comprising:
a migration source apparatus including:
a primary memory; and
a first processor coupled to the primary memory; and
a migration destination apparatus including:
a secondary memory; and
a second processor coupled to the secondary memory,
wherein
the first processor is configured to:
transmit data stored in a first memory of a migration source virtual machine operating on the migration source apparatus to a second memory of a migration destination virtual machine on a migration destination apparatus, the first memory being part of the primary memory, the second memory being part of the secondary memory;
suspend the migration source virtual machine after the transmission;
re-transmit re-written data stored in the first memory to the second memory, the re-written data being data re-written during the transmission; and
notify the migration destination apparatus of first time information related to a suspension time that is a time from the suspension of the migration source virtual machine to end of the re-transmission, and
the second processor is configured to:
adjust, in response to the notification of the first time information, second time information by adding the suspension time, the second time information being related to an internal clock of the migration source virtual machine and stored in the second memory; and
resume the migration destination virtual machine after the adjustment.

5. A non-transitory computer-readable recording medium having stored therein a program that causes a computer to execute a process, the process comprising:
transmitting data stored in a first memory of a migration source virtual machine operating on the computer to a second memory of a migration destination virtual machine on a migration destination apparatus;
suspending the migration source virtual machine after the transmission;
re-transmitting re-written data stored in the first memory to the second memory, the re-written data being data re-written during the transmission;
notifying the migration destination apparatus of first time information related to a suspension time to cause the migration destination apparatus to adjust second time information by adding the suspension time, the suspension time being a time from the suspension of the migration source virtual machine to end of the re-transmission, the second time information being related to an internal clock of the migration source virtual machine and stored in the second memory; and
causing, after the re-transmission, the migration destination apparatus to resume the migration destination virtual machine.
